(19) United States
(12) Patent Application Publication
(10) Pub. No.: US 2003/0068440 A1
(43) Pub. Date: Apr. 10, 2003

(54) Process for producing extraction-resistant polymer coatings

(75) Inventors: Peter Ottersbach, Windeck (DE); Beate Kossmann, Hagen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: CREAVIS Gesellschaft fuer Tech. und Innovation mbH, Marl (DE)

(21) Appl. No.: 10/267,580

(22) Filed: Oct. 10, 2002

(30) Foreign Application Priority Data
Oct. 10, 2001 (DE) 10149973.6

(51) Int. Cl. B05D 3/02

(52) U.S. Cl. 427/385.5

(57) ABSTRACT

A process for producing extraction-resistant polymer coatings on surfaces.

### BACKGROUND OF THE INVENTION

1. Field of the Invention

The present invention relates to a process for producing extraction-resistant polymer coatings, in particular antimicrobial coatings.

2. Description of the Background

It is highly undesirable for bacteria to become established or to spread on the surfaces of piping, or of containers or packaging. Slime layers frequently form and permit sharp rises in microbial populations, and these can lead to persistent impairment of the quality of water or of drinks or foods, and even to spoilage of the product and harm to the health of consumers.

Bacteria must be kept away from all areas of life in which hygiene is important. This affects textiles for direct body contact, especially in the genital area, and those used for the care of the sick or elderly. Bacteria must also be kept away from the surfaces of furniture and of instruments in patient-care areas, especially in areas for intensive care or neonatal care, and in hospitals, especially in areas where medical intervention takes place, and also in isolation wards for critical cases of infection, and in toilets.

A current method of treating equipment, or the surfaces of furniture or of textiles, to resist bacteria either when this becomes necessary or else as a precautionary measure is to use chemicals or solutions of these, or else mixtures which are disinfectant and have relatively broad general antimicrobial action. Chemical agents of this type act nonspecifically and are themselves frequently toxic or irritant, or form degradation products which are hazardous to health. In addition, people frequently exhibit intolerance to these materials once they have become sensitized.

Another method of counteracting surface spread of bacteria is to incorporate substances with antimicrobial action into a matrix.

Another challenge of constantly increasing significance is the avoidance of algal growth on surfaces, since there are now many external surfaces of buildings with plastic cladding, which is particularly susceptible to colonization by algae. As well as giving an undesirable appearance, this can in some circumstances also impair the functioning of the components concerned. One relevant example is colonization by algae of surfaces with a photovoltaic function.

Another form of microbial contamination for which again no technically satisfactory solution has been found is fungal infestation of surfaces. For example, Aspergillus niger infestation of joints or walls in wet areas within buildings not only impairs appearance but also has serious health implications, since many people are allergic to the substances given off by the fungi, and the result can even be serious, chronic respiratory disease.

In the marine sector, the fouling of boat hulls affects costs, since the growth of fouling organisms is attended by an increase in the boats' flow resistance, thus by a marked increase in fuel consumption. Problems of this type have hitherto generally been countered by incorporating toxic heavy metals or other low-molecular-weight biocides into antifouling coatings, with the aim of mitigating the problems described. To this end, the damaging side effects of coatings of this type are accepted, but as society's environmental awareness rises this state of affairs is increasingly problematic.

U.S. Pat. No. 4,532,269, for example, describes a terpolymer made from butyl methacrylate, tributyltin methacrylate, and tert-butylaminoethyl methacrylate. This copolymer is used as an antimicrobial paint for ships, and the hydrophilic tert-butylaminoethyl methacrylate promotes slow erosion of the polymer, thus releasing the highly toxic tributyltin methacrylate as active antimicrobial ingredient. In these applications, the copolymer prepared with aminomethacrylates is merely a matrix or carrier for added microbicidal ingredients which can diffuse or migrate out of the carrier material. Sooner or later, polymers of this type lose their activity, once the necessary minimum inhibitor concentration (MIC) at the surface has been lost. European patent application 0 862 858 also describes that copolymers of tert-butylaminoethyl methacrylate, a methacrylate with a secondary amino function, inherently have microbicidal properties. Systems developed in the future, too, will have to be based on novel compositions with improved effectiveness if undesirable resistance phenomena in the microbes are to be avoided, particularly bearing in mind the microbial resistance known from antibiotics research.

In many cases it is necessary to immobilize these contact-microbicidal polymers on surfaces in a manner which resists extraction, so that the polymers do not pass into the medium to be purified. This type of migration would be unacceptable in applications in food and drink or medical technology, for example.

Since the antimicrobial polymers are generally hydrophilic systems which, although they are not generally water-soluble, can undergo significant swelling brought about by water, and since the surrounding medium is generally aqueous, the result can be interaction of the medium with the antimicrobial constituents, and this can lead to swelling of the coating with the result that the coating is damaged. Changes of this type to the coating become visible through blistering or changes in the optical transparency of the film.

This can be avoided by incorporating the antimicrobial polymers into a matrix, i.e. fixing the polymers in such a way as to prevent damage to the film. However, this brings with it the disadvantage that a matrix of this type dilutes the active constituents of the antimicrobial polymer, and the antimicrobial effect is therefore reduced or, in adverse circumstances, even eliminated. This in turn requires an increase in the initial concentration of the antimicrobial polymers in the coating, but the price of the active components makes this economically undesirable. In addition, the development of a suitable coating is very costly and has to be repeated for each particular application.

Accordingly, there remains a continuing need for coatings which overcome these difficulties.

### SUMMARY OF THE INVENTION

It is an object of the present invention to provide methods for applying extraction-resistant coatings on almost any desired surface while avoiding the disadvantages described above.

Surprisingly, it has been found that the application of highly dilute polymer solutions can produce extremely thin and highly adherent coatings on surfaces. The coatings produced in this way have high mechanical and chemical resistance and undergo hardly any swelling, even when exposed to organic solvents.

The present invention therefore provides a process for preparing extraction-resistant polymer coatings on surfaces, where a solution or a dispersion of at least one polymer in a solvent is applied as a concentration of less than 0.1% by weight to a surface, and then the solvent is removed.

A more complete appreciation of the invention and many of the attendant advantages thereof will be readily obtained as the same becomes better understood by reference to the detailed description below.

### DETAILED DESCRIPTION OF THE INVENTION

In one version of the coating process of the invention, a dilute polymer solution is prepared by dissolving an appropriate amount of the polymer in a solvent, and then brought into contact with the article to be coated, e.g. the interior of a bottle.

In another version of the process, a dispersion is used, either via dispersion of the polymer, e.g. with a surfactant in water, or via emulsion polymerization with no subsequent work-up of the resultant reaction mixture. Emulsion polymerization to obtain a dispersion with the stated proportions by weight is known to those skilled in the art, e.g. by using high water content for the emulsion polymers or diluting the reaction product with water.

The contact should be as uniform as possible, and this can be ensured, for example in the case of a bottle, by uniformly rotating the bottle around its own axis. The polymer solution is then removed and the specimen is preferably dried in such a way that no inhomogeneities form within the coating. In the case of the example mentioned, i.e. the bottle, one way of achieving this is that during the drying procedure the bottle is permitted to rotate uniformly around its axes. In one particular embodiment of the process, in order to ensure that even the final residues of solvent are removed, a further drying step at elevated temperature and/or with application of reduced pressure is carried out after the main drying step.

Because the coating obtained according to the invention is so thin, it is likely that there is highly efficient interaction brought about by physi- or chemisorption on the substrate, with the result that the coating gains a high level of both extraction resistance and erosion resistance. Damage by the swelling processes mentioned is moreover virtually eliminated, and this is apparent in that, unlike with thicker layers, the transparency of the coating remains constant in contact with water.

The thickness of coatings produced according to the invention may be not more than 1000 nm, preferably from 0.1 to 800 nm, particularly preferably from 0.1 to 400 nm. These ranges include all specific values and subranges therebetween, such as 0.2, 0.5, 1, 2, 5, 10, 25, 50, 100, 250, 500, and 750 nm. In a preferred embodiment, the coatings produced according to the invention are completely transparent.

In preparing the polymers it is preferable to use nitrogen- or phosphorus functionalized monomers.

By suitably selecting monomers, it is possible to prepare polymers which are extraction-resistant and antimicrobial. Examples of suitable monomers for preparing (antimicrobial) polymers are 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-diethylaminoethyl methacrylate, 2 methacryloyloxyethyltrimethylammmonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenylphosphonium chloride, 2-acrylamido-2-methyl-1-propanesulfinic acid, 2-diethylaminoethyl vinyl ether, and 3-aminopropyl vinyl ether. Mixtures of these monomers may be used.

Solvents which may be used for the coating formulation are almost any of the organic solvents which dissolve the antimicrobial polymer at concentrations of from at least 1 to 10⁻⁴% by weight. Examples of these include alcohols, esters, ketones, aldehydes, ethers, acetates, aromatics, hydrocarbons, halogenated hydrocarbons, and organic acids, in each case on their own or in a mixture, in particular methanol, ethanol, propanol, butanol, acetone, methyl ethyl ketone, butyl acetate, acetaldehyde, ethylene glycol, propylene glycol, THF, diethyl ether, dioxane, toluene, n-hexane, cyclohexane, cyclohexanol, xylene, DMF, acetic acid, and chloroform, in each case individually or in a mixture.

Water can also be a suitable solvent, where appropriate with a dispersant or emulsifier, or with some other solubilizing substances, e.g. the solvents mentioned (in particular here the water-soluble solvents).

The polymer solutions used according to the invention have a polymer concentration of not more than 0.1% by weight. The solutions may also have greater dilution, e.g. from 0.01 to 10⁻⁴% by weight. Thus, the polymer concentration may be not more than 0.0001, 0.0002, 0.0005, 0.001, 0.002, 0.005, 0.01, 0.02, and 0.05. These ranges include all specific values and subranges therebetween.

In preparing the polymers, it is also possible to use one or more other aliphatically unsaturated monomers. Examples of suitable monomers are acrylic acid, tert-butyl methacrylate, methyl methacrylate, styrene or its derivatives, vinyl chloride, vinyl ethers, acrylamides, acrylonitriles, olefins (ethylene, propylene, butylene, isobutylene), allyl compounds, vinyl ketones, vinylacetic acid, vinyl acetate and vinyl esters, methyl methacrylate, ethyl methacrylate, butyl methacrylate, tert-butyl methacrylate, methyl acrylate, ethyl acrylate, butyl acrylate, and tert-butyl acrylate.

The polymer may have a weight-average molecular weight of from 20,000 to 5,000,000, preferably from 50,000 to 1,000,000 or 100,000 to 500,000.

Use of the modified polymer substrates

The present invention also provides the use of the antimicrobial coatings produced according to the invention for producing antimicrobial products, and the resultant products themselves. Products of this type are preferably based on polyamides, on polyurethanes, on polyether block amides, on polyesteramides or -imides, on PVC, on polyolefins, on silicones, on polysiloxanes, on polymethacrylate, or on polyterephthalates, or on metals, on wood, on glass, or on ceramics, which have surfaces coated with polymers of the invention.

Particular examples of antimicrobial products of this type are machine parts for the processing of food or drink, components of air conditioning systems, coated pipes, semifinished products, roofing, items for bathroom or toilet use, kitchen items, components of sanitary equipment, components of cages or housings for animals, recreational products for children, components of water systems, packaging for food or drink, operating units (touch panels) of devices, and contact lenses.

The coatings of the invention may be used anywhere wherein importance is placed on surfaces with release properties or surfaces which are as free as possible from bacteria, algae and fungi, i.e. are microbicidal. Examples of applications of the coatings of the invention are found in the following sectors:

Marine: boat hulls, docks, buoys, drilling platforms, ballast water tanks

Construction: roofing, basements, walls, facades, greenhouses, sun protection, garden fencing, wood protection

Sanitary: public conveniences, bathrooms, shower curtains, toilet items, swimming pools, saunas, jointing, sealing compounds

Food and drink: machines, kitchen, kitchen items, sponges, recreational products for children, food packaging, milk processing, drinking water systems, cosmetics

Machine parts: air conditioning systems, ion exchangers, process water, solar-powered units, heat exchangers, bioreactors, membranes

Medical technology: contact lenses, diapers, membranes, implants

Consumer articles: automobile seats, clothing (socks, sports clothing), hospital equipment, door handles, telephone handsets, public conveyances, animal cages, cash registers, carpeting, wall coverings.

The present invention also provides the use of items for medical technology or hygiene products produced according to the invention using coatings produced according to the invention or using the process of the invention. The above statements concerning preferred materials are again applicable. Examples of hygiene products of this type are toothbrushes, toilet seats, combs, and packaging materials. The term hygiene item also includes other objects which may come into contact with a large number of people, such as telephone handsets, stair rails, door handles, window catches, and grab straps and grab handles in public conveyances. Examples of items in medical technology are catheters, tubing, protective or backing films, and also surgical instruments.

The process of the invention is particularly suitable for coating the inner surfaces of pipes, cooling circuits, air conditioning systems, glass bottles, plastic bottles, drinking straws, drinks cartons, syringes, filling systems, or plastic bags.

The process may moreover be used for coating the protective covers of solar installations or of roofs, or coating windowpanes or transparent surfaces.

To obtain a uniform surface, it can be useful to use solvents or cleaners to clean the surfaces to be coated prior to application of the polymer solutions.

Suitable solvents or cleaners are the abovementioned solvents or aqueous solutions, where appropriate with a cleaning additive, such as a surfactant.

The process of the invention may in particular be used for the subsequent lining of closed or open systems. This means that, for example, closed cooling circuits may be subsequently be given a coating, e.g. an antimicrobial coating, by flushing them with a solution of polymers or with an appropriate dispersion having the proportions described of polymer, and then drying them. If desired, solvents/cleaners may be passed through the system prior to the coating process, in order to clean the surface prior to coating. This process is suitable for both new and used systems.

### EXAMPLES

The examples below are given for further description of the present invention, and provide further illustration of the invention but are not intended to restrict its scope as set out in the claims.

### Example 1

50 ml of tert-butylaminoethyl methacrylate (Aldrich) and 240 ml of ethanol are charged to a three-necked flask and heated to 65° C. under a stream of argon. 0.4 g of azobisisobutyronitrile dissolved in 15 ml of ethanol are then slowly added dropwise, with stirring. The mixture is heated to 70° C. and stirred at this temperature for 6 hours. After expiry of this time, the solvent is removed from the reaction mixture by distillation. The product is then dried in vacuo at 50° C. for 24 hours. The reaction product is then finely ground in a mortar.

### Example 1a

100 mg of the product of Example 1 are dissolved in 1 liter of cyclohexane. 5 ml of this solution are placed in a glass chemicals bottle of capacity 50 ml. This is sealed and placed on a roller mixer for 1 minute, a procedure which can ensure uniform contact between the inner side of the bottle and the solution. The bottle is then opened and the solution is removed, and the opened bottle is rotated on a roller mixer for 6 hours in a fume cupboard, with the result that residues of solvent are uniformly evaporated. The resultant predried coating is then further dried at about 1 mbar in a vacuum drying cabinet at 35° C. for 24 hours.

The bottle is extracted for 24 hours with 45 ml of water heated to 37° C. After this, the coating remains transparent. The water is removed and 2 ml thereof are placed in a glass beaker which is then treated with 20 ml of a test microbial suspension of Staphylococcus aureus, and shaken. After a contact time of 4 hours, 1 ml of the test microbial suspension is removed, and the number of microbes in the test mixture is determined. After expiry of this time, and taking into account the increased volume of liquid, the number of microbes has remained constant at 10⁷ microbes per ml.

20 ml of a test microbial suspension of Staphylococcus aureus are then placed into the bottle initially coated, which is then shaken. After a contact time of 4 hours, 1 ml of the test microbial suspension is removed, and the number of microbes in the test mixture is determined. After expiry of this time, no remaining microbes of Staphylococcus aureus are detectable.

### Example 1b

2000 mg of the product of Example 1 are dissolved in 1 liter of cyclohexane. 5 ml of this solution are placed in a glass chemicals bottle of capacity 50 ml. This is sealed and placed on a roller mixer for 1 minute, a procedure which can ensure uniform contact between the inner side of the bottle and the solution. The bottle is then opened and the solution is removed, and the opened bottle is rotated on a roller mixer for 6 hours in a fume cupboard, with the result that residues of solvent are uniformly evaporated. The resultant predried coating is then further dried at about 1 mbar in a vacuum drying cabinet at 35° C. for 24 hours.

The bottle is extracted for 24 hours with 45 ml of water heated to 37° C. After this, the coating remains opaque.

The water is removed and 2 ml thereof are placed in a glass beaker which is then treated with 20 ml of a test microbial suspension of Staphylococcus aureus, and shaken. After a contact time of 4 hours, 1 ml of the test microbial suspension is removed, and the number of microbes in the test mixture is determined. After expiry of this time, and taking into account the increased volume of liquid, the number of microbes has fallen from 10⁷, microbes per ml to 10⁴ microbes per ml.

20 ml of a test microbial suspension of Staphylococcus aureus are then placed into the bottle initially coated, which is then shaken. After a contact time of 4 hours, 1 ml of the test microbial suspension is removed, and the number of microbes in the test mixture is determined. After expiry of this time, no remaining microbes of Staphylococcus aureus are detectable.

### Example 1c

10 mg of the product of Example 1 are dissolved in 1 liter of cyclohexane. 5 ml of this solution are placed in a glass chemicals bottle of capacity 50 ml. This is sealed and placed on a roller mixer for 1 minute, a procedure which can ensure uniform contact between the inner side of the bottle and the solution. The bottle is then opened and the solution is removed, and the opened bottle is rotated on a roller mixer for 6 hours in a fume cupboard, with the result that residues of solvent are uniformly evaporated. The resultant predried coating is then further dried at about 1 mbar in a vacuum drying cabinet at 35° C. for 24 hours. No coating is detectable by the naked eye.

The bottle is extracted for 24 hours with 45 ml of water heated to 37° C. After this, the coating remains transparent.

The water is removed and 2 ml thereof are placed in a glass beaker which is then treated with 20 ml of a test microbial suspension of Staphylococcus aureus, and shaken. After a contact time of 4 hours, 1 ml of the test microbial suspension is removed, and the number of microbes in the test mixture is determined. After expiry of this time, and taking into account the increased volume of liquid, the number of microbes has remained constant at 10⁷ microbes per ml.

20 ml of a test microbial suspension of Staphylococcus aureus are then placed into the bottle initially coated, which is then shaken. After a contact time of 4 hours, 1 ml of the test microbial suspension is removed, and the number of microbes in the test mixture is determined. After expiry of this time, no remaining microbes of Staphylococcus aureus are detectable.

### Example 2

40 ml of dimethylaminopropylmethacrylamide (Aldrich) and 200 ml of ethanol are charged to a three-necked flask and heated to 65° C. under a stream of argon. 0.4 g of azobisisobutyronitrile dissolved in 20 ml of ethanol are then slowly added dropwise, with stirring. The mixture is heated to 70° C. and stirred at this temperature for 6 hours. After expiry of this time, the solvent is removed from the reaction mixture by distillation. The product is then dried in vacuo at 50° C. for 24 hours. The reaction product is then finely ground in a mortar.

### Example 2a

100 mg of the product of Example 2 are dissolved in 1 liter of cyclohexane. 5 ml of this solution are placed in a glass chemicals bottle of capacity 50 ml. This is sealed and placed on a roller mixer for 1 minute, a procedure which can ensure uniform contact between the inner side of the bottle and the solution. The bottle is then opened and the solution is removed, and the opened bottle is rotated on a roller mixer for 6 hours in a fume cupboard, with the result that residues of solvent are uniformly evaporated. The resultant predried coating is then further dried at about 1 mbar in a vacuum drying cabinet at 35° C. for 24 hours.

The bottle is extracted for 24 hours with 45 ml of water heated to 37° C. After this, the coating remains transparent.

The water is removed and 2 ml thereof are placed in a glass beaker which is then treated with 20 ml of a test microbial suspension of Staphylococcus aureus, and shaken. After a contact time of 4 hours, 1 ml of the test microbial suspension is removed, and the number of microbes in the test mixture is determined. After expiry of this time, and taking into account the increased volume of liquid, the number of microbes has remained constant at 10⁷ microbes per ml.

20 ml of a test microbial suspension of Staphylococcus aureus are then placed into the bottle initially coated, which is then shaken. After a contact time of 4 hours, 1 ml of the test microbial suspension is removed, and the number of microbes in the test mixture is determined. After expiry of this time, no remaining microbes of Staphylococcus aureus are detectable.

### Example 2b

2000 mg of the product of Example 2 are dissolved in 1 liter of cyclohexane. 5 ml of this solution are placed in a glass chemicals bottle of capacity 50 ml. This is sealed and placed on a roller mixer for 1 minute, a procedure which can ensure uniform contact between the inner side of the bottle and the solution. The bottle is then opened and the solution is removed, and the opened bottle is rotated on a roller mixer for 6 hours in a fume cupboard, with the result that residues of solvent are uniformly evaporated. The resultant predried coating is then further dried at about 1 mbar in a vacuum drying cabinet at 35° C. for 24 hours.

The bottle is extracted for 24 hours with 45 ml of water heated to 37° C. After this, the coating remains opaque.

The water is removed and 2 ml thereof are placed in a glass beaker which is then treated with 20 ml of a test microbial suspension of Staphylococcus aureus, and shaken. After a contact time of 4 hours, 1 ml of the test microbial suspension is removed, and the number of microbes in the test mixture is determined. After expiry of this time, and taking into account the increased volume of liquid, the number of microbes has fallen from 10⁷ microbes per ml to 10⁴ microbes per ml.

20 ml of a test microbial suspension of Staphylococcus aureus are then placed into the bottle initially coated, which is then shaken. After a contact time of 4 hours, 1 ml of the test microbial suspension is removed, and the number of microbes in the test mixture is determined. After expiry of this time, no remaining microbes of Staphylococcus aureus are detectable.

### Example 2c

10 mg of the product of Example 2 are dissolved in 1 liter of cyclohexane. 5 ml of this solution are placed in a glass chemicals bottle of capacity 50 ml. This is sealed and placed on a roller mixer for 1 minute, a procedure which can ensure uniform contact between the inner side of the bottle and the solution. The bottle is then opened and the solution is removed, and the opened bottle is rotated on a roller mixer for 6 hours in a fume cupboard, with the result that residues of solvent are uniformly evaporated. The resultant predried coating is then further dried at about 1 mbar in a vacuum drying cabinet at 35° C. for 24 hours. No coating is detectable by the naked eye.

The bottle is extracted for 24 hours with 45 ml of water heated to 37° C. After this, the coating remains transparent. The water is removed and 2 ml thereof are placed in a glass beaker which is then treated with 20 ml of a test microbial suspension of Staphylococcus aureus, and shaken. After a contact time of 4 hours, 1 ml of the test microbial suspension is removed, and the number of microbes in the test mixture is determined. After expiry of this time, and taking into account the increased volume of liquid, the number of microbes has remained constant at 10⁷ microbes per ml.

20 ml of a test microbial suspension of Staphylococcus aureus are then placed into the bottle initially coated, which is then shaken. After a contact time of 4 hours, 1 ml of the test microbial suspension is removed, and the number of microbes in the test mixture is determined. After expiry of this time, no remaining microbes of Staphylococcus aureus are detectable.

### Example 3

60 ml of tert-butylaminoethyl methacrylate (Aldrich) and 240 ml of ethanol are charged to a three-necked flask and heated to 65° C. under a stream of 25 argon. 0.4 g of azobisisobutyronitrile dissolved in 15 ml of ethanol are then slowly added dropwise, with stirring. The mixture is heated to 70° C. and stirred at this temperature for 6 hours. After expiry of this time, the solvent is removed from the reaction mixture by distillation. The product is then dried in vacuo at 50° C. for 24 hours. The reaction product is then finely ground in a mortar.

### Example 3a

100 mg of the product of Example 3 are dissolved in 1 liter of ethanol. 5 ml of this solution are placed in a PET bottle of capacity 50 ml. This is sealed and placed on a roller mixer for 1 minute, a procedure which can ensure uniform contact between the inner side of the bottle and the solution. The bottle is then opened and the solution is removed, and the opened bottle is rotated on a roller mixer for 6 hours in a fume cupboard, with the result that residues of solvent are uniformly evaporated. The resultant predried coating is then further dried at about 1 mbar in a vacuum drying cabinet at 35° C. for 24 hours.

The bottle is extracted for 24 hours with 45 ml of water heated to 37° C. After this, the coating remains transparent. The water is removed and 2 ml thereof are placed in a glass beaker which is then treated with 20 ml of a test microbial suspension of Staphylococcus aureus, and shaken. After a contact time of 4 hours, 1 ml of the test microbial suspension is removed, and the number of microbes in the test mixture is determined. After expiry of this time, and taking into account the increased volume of liquid, the number of microbes has remained constant at 10⁴ microbes per ml.

20 ml of a test microbial suspension of Staphylococcus aureus are then placed into the bottle initially coated, which is then shaken. After a contact time of 4 hours, 1 ml of the test microbial suspension is removed, and the number of microbes in the test mixture is determined. After expiry of this time, no remaining microbes of Staphylococcus aureus are detectable.

### Example 3b

2000 mg of the product of Example 3 are dissolved in 1 liter of ethanol. 5 ml of this solution are placed in a PET bottle of capacity 50 ml. This is 25 sealed and placed on a roller mixer for 1 minute, a procedure which can ensure uniform contact between the inner side of the bottle and the solution. The bottle is then opened and the solution is removed, and the opened bottle is rotated on a roller mixer for 6 hours in a fume cupboard, with the result that residues of solvent are uniformly evaporated. The resultant predried coating is then further dried at about 1 mbar in a vacuum drying cabinet at 35° C. for 24 hours. The bottle is extracted for 24 hours with 45 ml of water heated to 37° C. After this, the coating remains opaque.

The water is removed and 2 ml thereof are placed in a glass beaker which is then treated with 20 ml of a test microbial suspension of Staphylococcus aureus, and shaken. After a contact time of 4 hours, 1 ml of the test microbial suspension is removed, and the number of microbes in the test mixture is determined. After expiry of this time, and taking into account the increased volume of liquid, the number of microbes has fallen from 10⁷ microbes per ml to 10⁴ microbes per ml.

20 ml of a test microbial suspension of Staphylococcus aureus are then placed into the bottle initially coated, which is then shaken. After a contact time of 4 hours, 1 ml of the test microbial suspension is removed, and the number of microbes in the test mixture is determined. After expiry of this time, no remaining microbes of Staphylococcus aureus are detectable.

### Example 3c

10 mg of the product of Example 3 are dissolved in 1 liter of ethanol. 5 ml of this solution are placed in a PET bottle of capacity 50 ml. This is sealed and placed on a roller mixer for 1 minute, a procedure which can ensure uniform contact between the inner side of the bottle and the solution. The bottle is then opened and the solution is removed, and the opened bottle is rotated on a roller mixer for 6 hours in a fume cupboard, with the result that residues of solvent are uniformly evaporated. The resultant predried coating is then further dried at about 1 mbar in a vacuum drying cabinet at 35° C. for 24 hours. No coating is detectable by the naked eye.

The bottle is extracted for 24 hours with 45 ml of water heated to 37° C. After this, the coating remains transparent.

The water is removed and 2 ml thereof are placed in a glass beaker which is then treated with 20 ml of a test microbial suspension of Staphylococcus aureus, and shaken. After a contact time of 4 hours, 1 ml of the test microbial suspension is removed, and the number of microbes in the test mixture is determined. After expiry of this time, and taking into account the increased volume of liquid, the number of microbes has remained constant at 10⁷ microbes per ml.

20 ml of a test microbial suspension of Staphylococcus aureus are then placed into the bottle initially coated, which is then shaken. After a contact time of 4 hours, 1 ml of the test microbial suspension is removed, and the number of microbes in the test mixture is determined. After expiry of this time, no remaining microbes of Staphylococcus aureus are detectable.

### Example 4

45 ml of dimethylaminopropylmethacrylamide (Aldrich) and 200 mi of ethanol are charged to a three-necked flask and heated to 65° C. under a stream of argon. 0.5 g of azobisisobutyronitrile dissolved in 20 ml of ethanol are then slowly added dropwise, with stirring. The mixture is heated to 70° C. and stirred at this temperature for 6 hours. After expiry of this time, a solvent is removed from the reaction mixture by distillation. The product is then dried in vacuo at 50° C. for 24 hours. The reaction product is then finely ground in a mortar.

### Example 4a

100 mg of the product of Example 4 are dissolved in 1 liter of cyclohexane. An aluminum sheet of dimensions three×three centimeters is dipped into this solution for 5 seconds, and then slowly withdrawn from the solution.

The aluminum sheet is then dried for 6 hours in a fume cupboard, with the result that residues of solvent are uniformly evaporated. The resultant predried coating is then further dried at about 1 mbar in a vacuum drying cabinet at 35° C. for 24 hours.

The sheet is extracted for 24 hours with 45 ml of water heated to 37° C. After this, the coating remains transparent.

The water is removed and 2 mi thereof are placed in a glass beaker which is then treated with 20 ml of a test microbial suspension of Staphylococcus aureus, and shaken. After a contact time of 4 hours, 1 mi of the test microbial suspension is removed, and the number of microbes in the test mixture is determined. After expiry of this time, and taking into account the increased volume of liquid, the number of microbes has remained constant at 10⁷ microbes per ml.

The coated aluminum sheet is then shaken in 20 ml of a test microbial suspension of Staphylococcus aureus. After a contact time of 4 hours, 1 ml of the test microbial suspension is removed, and the number of microbes in the test mixture is determined. After expiry of this time, no remaining microbes of Staphylococcus aureus are detectable.

### Example 4b

2000 mg of the product of Example 4 are dissolved in 1 liter of cyclohexane. An aluminum sheet of dimensions three×three centimeters is dipped into this solution for 5 seconds, and then slowly withdrawn from the solution.

The aluminum sheet is then dried for 6 hours in a fume cupboard, with the result that residues of solvent are uniformly evaporated. The resultant predried coating is then further dried at about 1 mbar in a vacuum drying cabinet at 35° C. for 24 hours.

The sheet is extracted for 24 hours with 45 ml of water heated to 37° C. After this, the coating remains opaque.

The water is removed and 2 ml thereof are placed in a glass beaker which is then treated with 20 ml of a test microbial suspension of Staphylococcus aureus, and shaken. After a contact time of 4 hours, 1 ml of the test microbial suspension is removed, and the number of microbes in the test mixture is determined. After expiry of this time, and taking into account the increased volume of liquid, the number of microbes has fallen from 10⁷ microbes per ml to 10⁵ microbes per ml.

The coated aluminum sheet is then shaken in 20 ml of a test microbial suspension of Staphylococcus aureus. After a contact time of 4 hours, 1 ml of the test microbial suspension is removed, and the number of microbes in the test mixture is determined. After expiry of this time, no remaining microbes of Staphylococcus aureus are detectable.

### Example 4c

10 mg of the product of Example 4 are dissolved in 1 liter of cyclohexane. An aluminum sheet of dimensions three×three centimeters is dipped into this solution for 5 seconds, and then slowly withdrawn from the solution.

The aluminum sheet is then dried for 6 hours in a fume cupboard, with the result that residues of solvent are uniformly evaporated. The resultant predried coating is then further dried at about 1 mbar in a vacuum drying cabinet at 35° C. for 24 hours. No coating is detectable by the naked eye.

The sheet is extracted for 24 hours with 45 ml of water heated to 37° C. After this, the coating remains transparent.

The water is removed and 2 ml thereof are placed in a glass beaker which is then treated with 20 ml of a test microbial suspension of Staphylococcus aureus, and shaken. After a contact time of 4 hours, 1 ml of the test microbial suspension is removed, and the number of microbes in the test mixture is determined. After expiry of this time, and taking into account the increased volume of liquid, the number of microbes has remained constant at 10⁷ microbes per ml.

The coated aluminum sheet is then shaken in 20 ml of a test microbial suspension of Staphylococcus aureus. After a contact time of 4 hours, 1 ml of the test microbial suspension is removed, and the number of microbes in the test mixture is determined. After expiry of this time, no remaining microbes of Staphylococcus aureus are detectable.

Obviously, numerous modifications and variations of the present invention are possible in light of the above teachings. It is therefore to be understood that within the scope of the appended claims, the invention may be practiced otherwise than as specifically described herein.

This application is based on German Patent Application Serial No. 101 49 973.6, filed on Oct. 10, 2001.

1. A process for producing an extraction-resistant polymer coating on a surface, comprising:
applying a solution or a dispersion of at least one polymer in a solvent at a concentration of less than 0.1% by weight to a surface and then removing the solvent.

2. The process as claimed in claim 1, wherein the thickness of the coating is not more than 1000 nm.

3. The process as claimed in claim 1, wherein the polymer contains nitrogen and/or phosphorus groups.

4. The process as claimed in claim 1, wherein the polymer contains nitrogen groups.

5. The process as claimed in claim 1, wherein the polymer contains phosphorus groups.

6. The process as claimed in claim 1, wherein the polymer is prepared from at least one monomer selected from the group consisting of
2-tert-butylaminoethyl methacrylate, 2-diethylaminoethyl methacrylate, 2-diethylaminomethyl methacrylate, 2-tertbutylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-diethylaminoethyl methacrylate, 2-methacryloyloxyethyltrimethylammmonium chloride, 3-methacryloylaminopropyltrimethylammonium chloride, 2-methacryloyloxyethyltrimethyl-ammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenylphosphonium chloride, 2-acrylamido-2-methyl-1-propanesulfonic acid, 2-diethyl aminoethyl vinyl ether, and 3-aminopropyl vinyl ether.

7. The process as claimed in claim 6, wherein the polymer is prepared from one or more additional aliphatically unsaturated monomers.

8. The process as claimed in claim 7, wherein the one or more additional aliphatically unsaturated monomers are acrylic acid, tertbutyl methacrylate, methyl methacrylate, styrene or its derivatives, vinyl chloride, vinyl ethers, acrylamides, acrylonitriles, olefins, allyl compounds, vinyl ketones, vinylacetic acid, vinyl acetate or vinyl ethers, methyl methacrylate, ethyl methacrylate, butyl methacrylate, tert-butyl methacrylate, methyl acrylate, ethyl acrylate, butyl acrylate, and/or tert-butyl acrylate.

9. The process as claimed in claim 8, wherein the olefins are ethylene, propylene, butylene, or isobutylene.

10. The process as claimed in claim 1, wherein the solvent comprises water, an alcohol, an ester, a ketone, an aldehyde, an ether, an acetate, an aromatic, a hydrocarbon, a halogenated hydrocarbon, or an organic acid, or a mixture thereof.

11. The process as claimed in claim 1, wherein the surface is an inner surface of pipes, cooling circuits, air conditioning systems, glass bottles, plastic bottles, drinking straws, drinks cartons, syringes, filling systems, or plastic bags.

12. The process as claimed in claim 1, wherein the surface is a protective cover for solar installations or for roofs, or is a window pane or transparent surface.

13. The process as claimed in claim 1, wherein the surface has been cleaned with a solvent or cleaner prior to the application of the solution or the dispersion.

14. The process as claimed in claim 1, wherein the thickness of coatings is 0.1 to 800 nm.

15. The process as claimed in claim 1, wherein the thickness of the coating is 0.1 to 400 nm.

16. The process as claimed in claim 1, wherein the coating is transparent.

17. The process as claimed in claim 1, wherein the solvent comprises one or more members selected from the group consisting of methanol, ethanol, propanol, butanol, acetone, methyl ethyl ketone, butyl acetate, acetaldehyde, ethylene glycol, propylene glycol, THF, diethyl ether, dioxane, toluene, n-hexane, cyclohexane, cyclohexanol, xylene, DMF, acetic acid, and chloroform.

18. The process as claimed in claim 1, wherein solvent comprises water.

19. The process as claimed in claim 18, wherein the water contains a dispersant and/or emulsifier.

20. The process as claimed in claim 1, wherein the concentration of the polymer is 0.01 to 10⁻⁴% by weight.

21. The process as claimed in claim 1, wherein the coating has antimicrobial properties.

22. The process as claimed in claim 1, wherein the surface is composed of a polyamide, polyurethane, polyether block amide, polyesteramide or -imide, PVC, polyolefin, silicone, polysiloxane, polymethacrylate, or polyterephthalate, metal, wood, glass, or ceramic.

23. The process as claimed in claim 1, wherein surface is a component of a member selected from the group consisting of machine parts for the processing of food or drink, components of air conditioning systems, coated pipes, semifinished products, roofing, items for bathroom or toilet use, kitchen items, components of sanitary equipment, components of cages or housings for animals, recreational products for children, components of water systems, packaging for food or drink, operating units (touch panels) of devices, and contact lenses.

24. The process as claimed in claim 1, wherein the surface is part of a member selected from the group consisting of boat hulls, docks, buoys, drilling platforms, ballast water tanks, roofing, basements, walls, facades, greenhouses, sun protection, garden fencing, wood protection, public conveniences, bathrooms, shower curtains, toilet items, swimming pools, saunas, jointing, sealing compounds, machines, kitchen, kitchen items, sponges, recreational products for children, food packaging, milk processing, drinking water systems, cosmetics, air conditioning systems, ion exchangers, process water, solar-powered units, heat exchangers, bioreactors, membranes, contact lenses, diapers, membranes, implants, automobile seats, clothing, hospital equipment, door handles, telephone handsets, public conveyances, animal cages, cash registers, carpeting, and wall coverings.

25. The process as claimed in claim 1, wherein the surface is part of a member selected from the group consisting of items for medical technology and hygiene products.

26. The process as claimed in claim 1, wherein the surface is part of a member selected from the group consisting of toothbrushes, toilet seats, combs, packaging materials, telephone handsets, stair rails, door handles, window catches, grab straps, grab handles, catheters, tubing, protective or backing films, and surgical instruments.
